(19) United States
(12) Patent Application Publication
(10) Pub. No.: US 2009/0031208 A1
(43) Pub. Date: Jan. 29, 2009

(54) Expanding Rows and Cells Within a Table

(75) Inventor: Alexander D. ROBINSON, Austin, TX (US)

Correspondence Address: IBM ST-SVL;SAWYER LAW GROUP LLP, 2465 E. Bayshore Road, Suite No. 406, PALO ALTO, CA, 94303, US

(73) Assignee: International Business Machines Corporation, Armonk, NY (US)

(21) Appl. No.: 11/828,967

(22) Filed: Jul. 26, 2007

(51) Int. Cl. G06F 17/00

(52) U.S. Cl. 715/227

(57) ABSTRACT

A method for modifying a table to show cell and row details. In one embodiment, the method includes receiving a command to expand a row with multiple cells to disclose details or in another embodiment to expand a single cell of a row, shifting the cells positioned below the row downward and expanding the row. The row or individual cell is expanded by displaying a detail region that is contiguous to row and positioned below the row. The cells positioned below the expanded row are shifted downward to provide sufficient space for the detail region such that the detail region does not hide any portion of any of the cells positioned below the expanded row.

### FIELD OF THE INVENTION

The present invention relates to software and web applications, and more particularly to a method for modifying table displays.

### BACKGROUND OF THE INVENTION

Tables used in software applications such as spreadsheets are well known. Tables enable a user to organize data into a comprehendible and attractive manner. For example, in a table, a user can enter data into the cells of a column and can create a header over the column. A header can, for example, identify a particular attribute (e.g., number value) of the data within the row. This process can be repeated for multiple columns, each having a specific attribute. The user can also create a header or label for each of the rows. The header can, for example, identify a particular object (e.g., a person) to which the cells within the row are associated.

In some software applications, some information might initially be hidden from the user until it is needed, such as metadata or other details regarding the cell information. This information may be displayed in a pop-up graphical box (e.g., a comment box) that the user can open and close. This enables a user to view additional information as needed. However, when the box is open, it covers or hides other cells. This is problematic when the user simultaneously wants to view the content of the hidden cells in order to make comparisons.

Accordingly, what is needed is an improved method for disclosing information through modifying table display. The present invention addresses such a need.

### SUMMARY OF THE INVENTION

A method for modifying table details is disclosed. In one embodiment, the method includes receiving a command to expand at least one cell of a table, where the command is initiated when a user clicks on a selectable portion of the table, where the selectable portion is a visual cue that indicates the command, and where the selectable portion is associated with the at least one cell. The method also includes shifting the cells positioned below at least one cell downward based on the size of the detail region, where the cells positioned below the cell are shifted downward, and where the detail region does not hide any portion of any of the cells positioned below. The method also includes displaying a detail region, where the detail region is contiguous to at least one cell, where the detail region is touching at least one cell, and where the detail region is positioned below at least one cell. The method also includes locking the detail region such that the detail region remains displayed until a command is received to unlock and hide the detail region, where a user can modify the contents of the cells of the table, including at least one cell and including the cells surrounding at least one cell while the detail region remains displayed, and wherein a user can modify the contents of the detail region while the detail region is displayed. If at least one cell is a row of multiple cells, the method includes disabling the cells in the row such that the cells in the row cannot be expanded simultaneously with an expanded cell of the same row, where the cells in the row are disabled until the detail region associated with the at least one cell is unlocked and hidden. Details can be shown on a row level which show details pertaining to the entire row, or on a specific cell level where the details pertain only to the information in that cell. If at least one cell is a single cell, the method includes disabling the row containing the single cell and other cells in the row such that the row and the other cells cannot be expanded simultaneously, where the row containing the single cell and the other cells in the row containing the single cell are disabled until the detail region associated with the at least one cell is unlocked and hidden or the user decides to open another cell in which case the previous cell detail closes to allow the other one to open. According to the method disclosed herein, a user can view details associated with the expanded row or cell and simultaneously view the surrounding cells. Multiple rows or cells can be expanded in a single table, but if the cells belong to the same row, only one cell or row at a time can be expanded to show details.

### BRIEF DESCRIPTION OF THE DRAWINGS

FIG. 1 is a block diagram of a computer system.

FIG. 2 is a screen shot of a table in accordance with one embodiment.

FIG. 3 is a screen shot of the table of FIG. 2 where one of the rows is expanded, in accordance with one embodiment.

FIG. 4 is a flow chart showing a method for modifying a table in accordance with one embodiment.

FIG. 5 is a screen shot of the table of FIG. 2 in accordance with one embodiment.

FIG. 6 is a screen shot of the table of FIG. 5 where one of the cells is expanded, in accordance with one embodiment.

### DETAILED DESCRIPTION OF THE INVENTION

The present invention relates to software applications, and more particularly to a method for modifying tables. The following description is presented to enable one of ordinary skill in the art to make and use the invention, and is provided in the context of a patent application and its requirements. Various modifications to the preferred embodiment and the generic principles and features described herein will be readily apparent to those skilled in the art. Thus, the present invention is not intended to be limited to the embodiments shown, but is to be accorded the widest scope consistent with the principles and features described herein.

A method in accordance with the present invention for modifying a table is disclosed. The method includes receiving a command to expand a row, shifting the cells positioned below the row downward, and expanding the row. In one embodiment, the row is expanded by displaying a detail region that is contiguous to the row and positioned below the row. The cells positioned below the expanded row are shifted downward to provide sufficient space for the detail region such that the detail region does not hide any portion of any of the cells positioned below the expanded row. In another embodiment, the application may expand a single cell in a similar manner. As a result, a user can view details associated with the expanded row or cell and simultaneously view the surrounding cells. To more particularly describe the features of the present invention, refer now to the following description in conjunction with the accompanying figures.

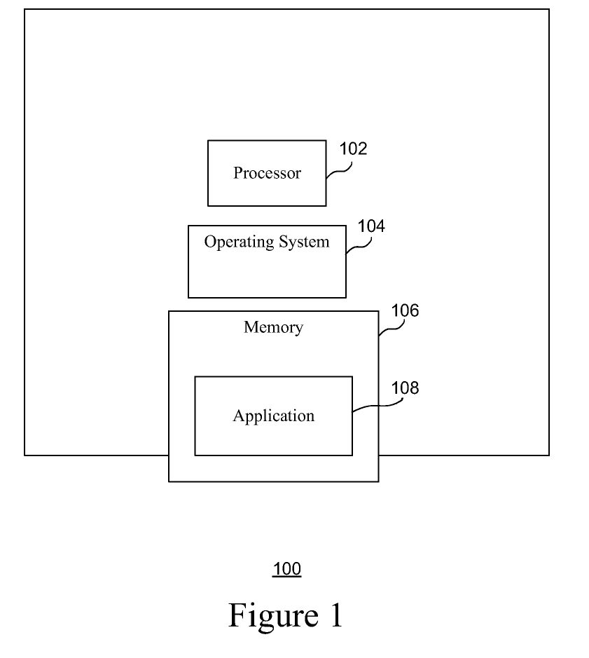

FIG. 1 is a block diagram of a computer system 100. As FIG. 1 shows, the computer system 100 includes a processor 102, an operating system 104, a memory 106, and an application 108. The application 108 is stored on the memory 106 or on any other suitable storage location or computer-readable medium. The application 108 provides instructions that enable the processor 102 to perform the functions described herein.

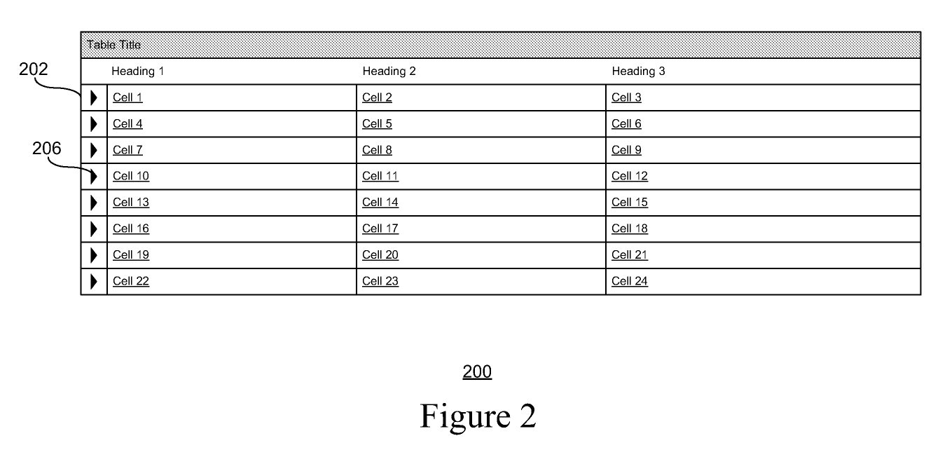

FIG. 2 is a screen shot of a table 200 in accordance with one embodiment. As FIG. 2 shows, the table 200 includes rows 202 and columns 204 of cells.

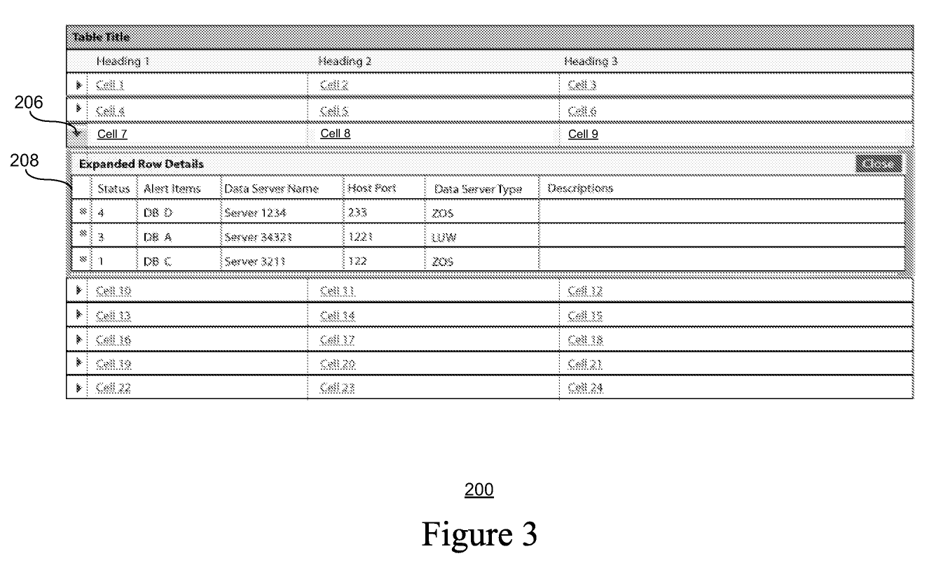

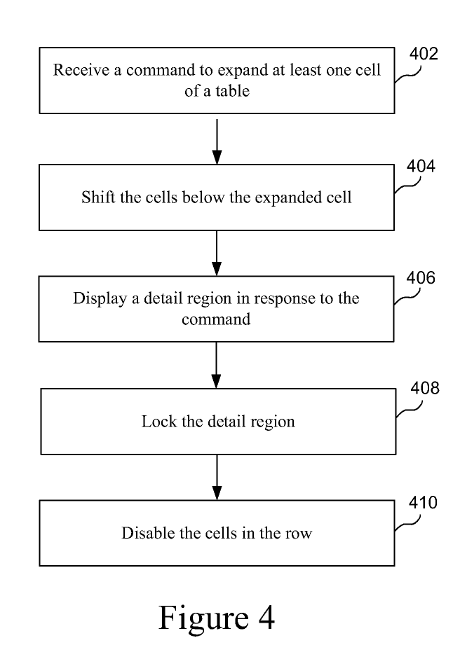

FIG. 3 is a screen shot of the table 200 of FIG. 2 where one of the rows is expanded, in accordance with one embodiment. As FIGS. 2 and 3 show, in one embodiment, each row includes a button that a user can click on to expand the row associated with the button. As FIG. 3 shows, when a user clicks on the button 206, the row expands to include a detail region 208. This operation is described in more detail below in connection to FIG. 4.

FIG. 4 is a flow chart showing a method for modifying a table in accordance with one embodiment. Referring to FIGS. 2, 3, and 4 together, the process begins in step 402 where the application 108 receives a command to expand at least one cell of a table. As indicated above, in one embodiment, the command may be initiated when a user clicks on a button 206 associated with a given row. In other embodiments, the command can be initiated by the user in other ways such as clicking on any suitable portion of the table or visual cue that indicates the command.

Next, in step 404, the application 108 shifts the cells positioned below the expanded row away from the expanded row, and, in step 406, the application 108 expands the associated row by displaying a detail region 208. Steps 404 and 406 may occur substantially simultaneously. In one embodiment, expanding the cell means that an adjacent area outside the cell expands to disclose information. In one embodiment, the original size of the original cell and the size of the surrounding cells remain fixed. The content of the original cell and the content of the surrounding cells remain intact.

As FIG. 3 shows, the cells positioned below the expanded row are shifted downward to provide space for the detail region 208, which is positioned below the row. In other embodiments, the detail region 208 may be positioned at other locations relative to the row (e.g., above or to the side of the row). In one embodiment, the detail region 208 is contiguous to the row. While FIG. 3 shows that the detail region 208 is touching the row, in other embodiments, the detail region 208 may be separate from the row. As FIG. 3 shows, the detail region does not hide any portion of any of the cells positioned below the expanded row, because those cells are shifted based on the size of the detail region. In one embodiment, the row remains intact as it expands. This enables a user to still view and modify the row while it is expanded. In some embodiments, the row may be transformed into a tab.

Next, in step 408, the application 108 locks the detail region 208 such that the detail region 208 remains displayed until receiving a command to unlock and hide the detail region 208. In one embodiment, the user may unlock and hide the detail region 208 by re-clicking the same button that expanded the row. In one embodiment, while the detail region remains displayed, the user can view and modify the contents of the cells of the table, including the cells of the row, the cells surrounding the row, and the contents of the detail region. This also enables a user to conveniently compare data or other information in any of the cells or detail region, as the detail region would not block any of the surrounding cells from view.

Next, in step 410, the application 108 disables other cells in the row such that such that individual cells in the row cannot be expanded. In one embodiment, the cells in the row are disabled until the detail region associated with the at least one cell is unlocked and hidden.

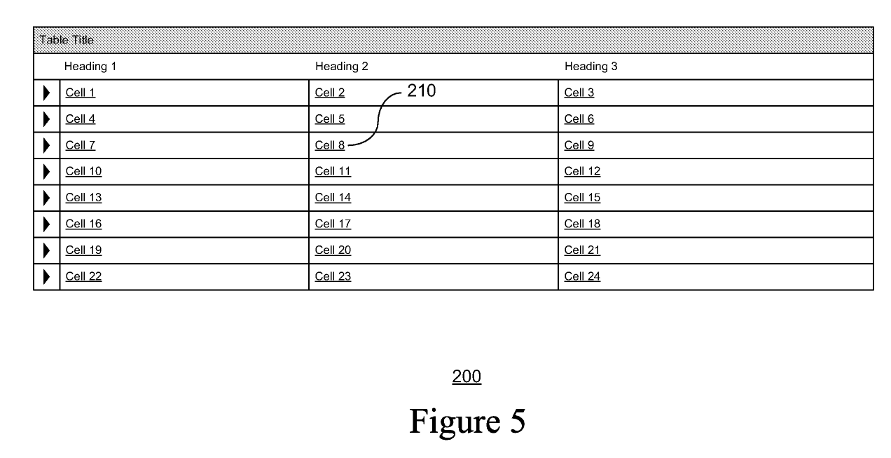

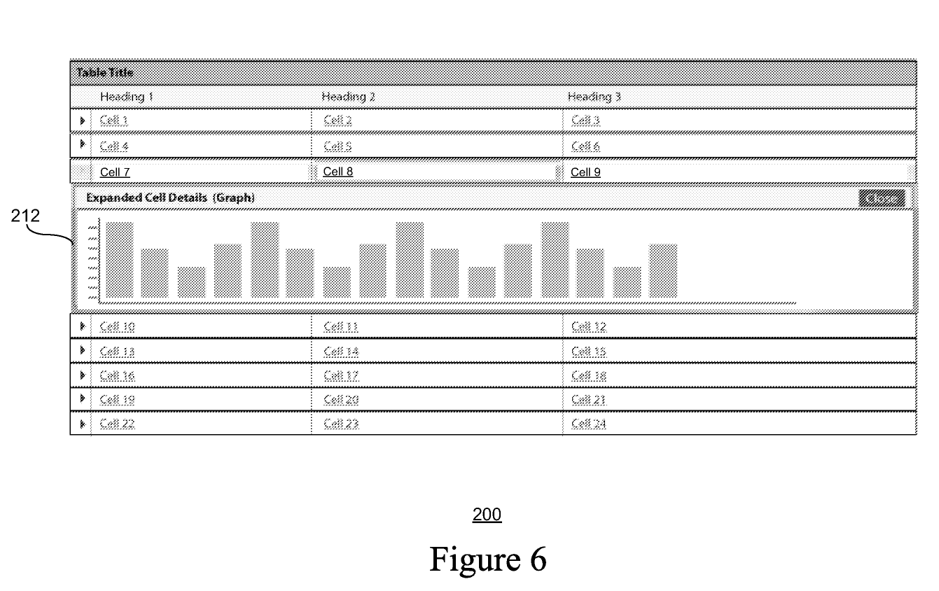

FIG. 5 is a screen shot of the table 200 of FIG. 2 in accordance with one embodiment. FIG. 6 is a screen shot of the table 200 of FIG. 5 where one of the cells is expanded, in accordance with one embodiment. As FIGS. 5 and 6 show, in one embodiment, some of the cells include links. For a given link 210, a user can click on the link 210 (or other suitable button) to expand the cell associated with the link 210. As FIG. 6 shows, when a user clicks on the link 210, the cell associated with the link expands to include a detail region 212. FIG. 6 shows a graph in the detail region 212. This operation is similar to that described above in connection to FIG. 4.

In one embodiment, a user may expand multiple rows and individual cells in the same table simultaneously as long as a given cell and the row that contains that cell are not expanded simultaneously. In other words, if a first row is expanded, a second row or another cell that is not associated with the first or second rows may also be expanded, concurrently. As such, the application 108 can simultaneously display multiple detail regions corresponding to different rows and to different single cells of the same table.

As FIGS. 2-6 show, embodiments enable a user to compare data across cells even when any of the cells are expanded. For monitoring, the ability to compare cells is a valuable feature. Embodiments achieve this because the application does not collapse any adjacent cells, but instead shifts the cells away from the expanded cell to provide sufficient space for the detail region. Embodiments also enable a user to place content such as buttons, pictures or even another table within the expanded area, as shown in FIG. 3. Embodiments of the present invention may be applied to spreadsheet applications as well to web applications and monitoring applications, etc. Embodiments of the present invention may also be applied to dashboard applications where grid data may be given in the form of alerts. Allowing the cells to expand provides details of these alerts that a user may also update.

According to the system and method disclosed herein, the present invention provides numerous benefits. For example, embodiments of the present invention enable a user to view details associated with an expanded row or cell while simultaneously viewing expanded row or cell and the surrounding cells. Embodiments of the present invention also enable to user to modify the contents of the expanded row or cell and the contents of the surrounding cells while the detail region is visible.

A method for modifying a table has been disclosed. The method includes receiving a command to expand a row and shifting the cells positioned below the row downward and expanding the row. In one embodiment, the row is expanded by displaying a detail region that is contiguous to the row and positioned below the row. The cells positioned below the expanded row are shifted downward to provide sufficient space for the detail region such that the detail region does not hide any portion of any of the cells positioned below the expanded row.

The present invention has been described in accordance with the embodiments shown. One of ordinary skill in the art will readily recognize that there could be variations to the embodiments, and that any variations would be within the spirit and scope of the present invention. For example, embodiments of the present invention may be implemented using hardware, software, a computer-readable medium containing program instructions, or a combination thereof. Software written according to the present invention or results of the present invention may be stored in some form of computer-readable medium such as memory, hard drive, CD-ROM, DVD, or other media for subsequent purposes such as being executed or processed by a processor, being displayed to a user, etc. Also, software written according to the present invention or results of the present invention may be transmitted in a signal over a network. In some embodiments, a computer-readable medium may include a computer-readable signal that may be transmitted over a network. Accordingly, many modifications may be made by one of ordinary skill in the art without departing from the spirit and scope of the appended claims.

What is claimed is:

1. A method for modifying a table, the method comprising:
receiving a command to expand at least one cell of a table, wherein the command is initiated when a user clicks on a selectable portion of the table, wherein the selectable portion is a visual cue that indicates the command, and wherein the selectable portion is associated with the at least one cell;
shifting the cells positioned below the at least one cell away from the at least one cell downward based on the size of the detail region, wherein the cells positioned below the at least one cell are shifted downward, and wherein the detail region does not hide any portion of any of the cells positioned below the least one cell;
displaying a detail region, wherein the detail region is contiguous to the at least one cell, and wherein the detail region is touching the at least one cell, wherein the detail region is positioned below the at least one cell;
locking the detail region such that the detail region remains displayed until a command is received to unlock and hide the detail region, wherein a user can modify the contents of the cells of the table, including the at least one cell and including the cells surrounding the at least one cell while the detail region remains displayed, and wherein a user can modify the contents of the detail region while the detail region is displayed;
if the at least one cell is a row of cells, disabling the cells in the row such that the cells in the row cannot be expanded, wherein the cells in the row are disabled until the detail region associated with the at least one cell is unlocked and hidden; and
if the at least one cell is a single cell, disabling the row containing the single cell and other cells in the row such that the row and the other cells cannot be expanded, wherein the row containing the single cell and the other cells in the row containing the single cell are disabled until the detail region associated with the at least one cell is unlocked and hidden.

2. The method of claim 1 wherein the at least one cell is a row of cells.

3. The method of claim 1 wherein the at least one cell is a single cell.

4. The method of claim 1 further comprising displaying multiple detail regions, wherein each detail region corresponds to a different row of cells of the same table or to different single cells of the same table, wherein all of the multiple detail regions are displayed simultaneously.

5. A computer-readable medium containing program instructions for modifying a table, the program instructions which when executed by a computer system cause the computer system to execute a method comprising:
receiving a command to expand at least one cell of a table, wherein the command is initiated when a user clicks on a selectable portion of the table, wherein the selectable portion is a visual cue that indicates the command, and wherein the selectable portion is associated with the at least one cell;
shifting the cells positioned below the at least one cell away from the at least one cell downward based on the size of the detail region, wherein the cells positioned below the at least one cell are shifted downward, and wherein the detail region does not hide any portion of any of the cells positioned below the least one cell;
displaying a detail region, wherein the detail region is contiguous to the at least one cell, and wherein the detail region is touching the at least one cell, wherein the detail region is positioned below the at least one cell;
locking the detail region such that the detail region remains displayed until a command is received to unlock and hide the detail region, wherein a user can modify the contents of the cells of the table, including the at least one cell and including the cells surrounding the at least one cell while the detail region remains displayed, and wherein a user can modify the contents of the detail region while the detail region is displayed;
if the at least one cell is a row of cells, disabling the cells in the row such that the cells in the row cannot be expanded, wherein the cells in the row are disabled until the detail region associated with the at least one cell is unlocked and hidden; and
if the at least one cell is a single cell, disabling the row containing the single cell and other cells in the row such that the row and the other cells cannot be expanded, wherein the row containing the single cell and the other cells in the row containing the single cell are disabled until the detail region associated with the at least one cell is unlocked and hidden.
